(19) United States
(12) Patent Application Publication
(10) Pub. No.: US 2015/0100360 A1
(43) Pub. Date: Apr. 9, 2015

(54) AUTOMATED METHOD AND SYSTEM FOR SELECTING AND MANAGING IT CONSULTANTS FOR IT PROJECTS

(71) Applicant: SARAVANAN SESHADRI, Tampa, FL (US)

(72) Inventor: SARAVANAN SESHADRI, Tampa, FL (US)

(21) Appl. No.: 14/503,428

(22) Filed: Oct. 1, 2014

Related U.S. Application Data
(60) Provisional application No. 61/888,006, filed on Oct. 8, 2013.

(51) Int. Cl. G06Q 10/06

(52) U.S. Cl. CPC G06Q 10/063118; G06Q 10/063112
USPC 705/7.14

(57) ABSTRACT

Techniques for selecting and managing IT consultants and IT projects are described. In one example embodiment, a list including IT consultant roles needed for performing various types of IT projects are defined. Each IT consultant's role along with obtaining associated IT consultant's skill score is then further defined by assessing each IT consultant for a possible one of identified IT consultant roles based on configurable IT consultant skill factors. Key IT consultant roles and associated IT consultant fitness scores along with numbers of each determined key IT consultant roles needed for the IT project are then determined. The IT consultants are then are then selected based on the defined IT consultant's roles and the associated IT consultant's skill scores and the determined key IT consultant roles. The selected IT consultants are then deployed and monitored on the IT project.

### BACKGROUND

Generally, Information technology (IT) projects' success, within the boundaries set for time frame, budget, quality and the like, for a given scope, depends on the performance of each IT consultant. Talent analytics is an area that is attracting substantial interest in academia and industry. Many articles present a broad discussion on how firms compete in talent analytics and numerous examples of how leading multinational companies are using sophisticated analytics to get the most of their talent data. For example, some companies find employees having a track record of taking initiative might be better hires than simply those who have education from top schools. Other companies find employees who were bloggers performed better than others. For example, some retailers find a 0.1% increase in employee engagement can result in about $100K increase in store profits. Furthermore, in call centers the attitude of an employee's supervisor may be more important for retention than other metrics.

Today's firms and companies deploy many approaches for using such analytics in the human resource optimization efforts; one such approach captures “how many employees would recommend the company as a place to work”. Another such approach uses more than simply measuring metrics to get insight by looking at differences, such as why a specific metric varies among different regions or segments in an organization. Yet another approach look to relate human resource (HR) metrics with business outcomes in a comprehensive manner, such as monitoring satisfaction over time and understanding how it relates to reducing costs and/or increasing revenues. Yet another approach uses talent analytics to derive workforce forecasts critical to planning and costs. Yet another approach uses talent analytics to improve employee retention and improved business performance. It can be seen in all of the above approaches and in the current business environment, that analytics are widely deployed in talent selection and management. While there are numerous examples of anecdotal evidence of companies using analytics in their human resource optimization efforts, there is less clarity on the current approaches for implementing them. These gaps in implementation approaches extend to IT consultants deployed on IT projects. Without an implementation approach and accompanying system to ensure proper talent assignment, measurement, and project-level coordination of this information, the incorrect choice and deployment of IT consultants can lead to time extension, budget expansion, reduced scope and quality issues in most IT projects.

### SUMMARY

One or more embodiments disclosed herein provide a method for selecting and managing IT consultants and for IT projects. In one aspect, the method includes defining a list of IT consultant roles needed for performing various types of IT projects by an IT consultant preparation and identification module. Each IT consultant's role along with obtaining associated IT consultant's skill score are then further defined by assessing each IT consultant for a possible one of identified IT consultant roles based on configurable IT consultant skill factors by the IT consultant preparation and identification module. Key IT consultant roles and associated IT consultant fitness scores along with numbers of each determine key IT consultant roles needed for the IT project are then determined by evaluating the IT project based on IT project profiling factors and the identified list of IT consultant roles by a IT project data collection and IT consultant role selection module. The IT consultants for deploying on an IT project are then selected based on the defined IT consultant's roles, the associated IT consultant's skill scores, the determined key IT consultant roles and the associated IT consultant fitness scores. Also, the IT consultants are selected based on the numbers of each determined key IT consultant roles needed for the IT project by an IT consultant and IT project matching module. The selected IT consultants are then deployed on the IT project based on their availability by an IT consultant and IT project delivery module.

Further embodiments of the present disclosure include a non-transitory computer-readable storage medium that includes instructions that enable a processing unit to implement one or more of the methods set forth above or the functions of the computer system set forth above. In one embodiment, a non-transitory computer-readable storage medium is provided having instructions that manage execution of a host computing machine. The instructions, when executed in a computing device, perform the steps for selecting and managing IT consultants for IT projects.

Embodiments of the present disclosure provide a computer system. The computing system includes multiple host computing systems in a datacenter. The computing system further includes a network that is communicatively coupled to the multiple host computing systems. Moreover, the computing system includes a management server that is communicatively coupled to the network, wherein the management server includes a IT consultant preparation and identification module, IT project data collection and IT consultant role selection module, IT consultant and IT project matching module, IT consultant and IT project delivery module, and IT performance and feedback module, wherein the modules are configured to select and manage IT consultants for IT projects.

### BRIEF DESCRIPTION OF THE DRAWINGS

FIG. 1 is a block diagram illustrating system for selecting and managing IT consultants for IT projects, according to an example embodiment.

FIG. 2 is a block diagram illustrating major components of IT consultant and identification module, such as those shown FIG. 1, according to an example embodiment.

FIG. 3 is a block diagram illustrating major components of IT project data collection and IT consultant role selection module, such as those shown in FIG. 1, according to an example embodiment.

FIG. 4 is a block diagram illustrating major components of IT consultant and IT project matching module, such as those shown in FIG. 1, according to an example embodiment.

FIG. 5 is a block diagram illustrating major components of IT consultant and IT project delivery module, such as those shown in FIG. 1, accordingly to an example embodiment.

FIG. 6 is a block diagram illustrating dataflow amongst the major components IT consultants and IT identification module, such as those shown in FIG. 2, accordingly to an example embodiment.

FIG. 7 is a schematic diagram showing a signal based IT consultant fitness score construction, according to an example embodiment.

FIG. 8 is an example schematic diagram showing configurable data sources for signals.

FIGS. 9A, 9B, and 9C are example schematic diagrams showing configurable IT consultant fitness score aggregations.

FIG. 10 is a schematic diagram of a framework deployed in IT consultant/IT consultant role matching, according to an example embodiment.

FIG. 11 is an example friendly user interface showing the presentation of bringing together results of UltraSure Score and UltraSure Fit modules.

FIG. 12 is a flow diagram of a process for optimizing guest operating system utilization cost in a volume based licensing model in a virtual datacenter, according to an example embodiment.

### DETAILED DESCRIPTION

Embodiments described herein provide a technique for selecting and managing IT consultants for IT projects. The technique further provides a robust hardware/software framework/platform/solution for IT consultants to succeed in IT projects. Furthermore the technique provides an end-to-end approach to ensure success and improved performance of IT consultants on IT projects. The technique begins with recruiting and identifying the right IT consultant for the IT project and further provides a support system for the IT consultant's successful delivery of their project responsibilities for successful execution of IT projects. The proposed technique provides a personalized approach to each IT consultant based on the premise that each IT consultant provides a unique combination of talents, expertise and skill-set. Further the proposed technique does not generalize the selection and management of IT consultants for IT projects, but rather treats each customer and each project as unique. Furthermore, the proposed technique ensures that an IT consultant with the most ideal match is selected and managed for the IT project. For example, an IT project that is in the initial stage requires a different skill-set than an IT project that may be in support and maintenance stage. Moreover the proposed technique monitors each IT project based on a customized key performance indicator (KPI) model and the monitoring interval may be selected based on a project lifecycle and maturity (referred to as PARIS (planning, assess, recommend, implement, and sustain (PARIS)) stage of the IT project and the company's maturity level operating the IT project. In addition the proposed technique provides each IT consultant a unique support system that is driven via a social media and otherwise collaborative-based approach to provide a complete ecosystem. Also, the proposed technique provides a secure way to protect customer confidentiality and complies with any security and privacy requirements of the IT project, such as the Health Information Technology for Economic and Clinical Health Act (HITECH Act).

The terms “signals” and “data coming from various data sources” are being used interchangeably throughout the document.

### System Overview and Examples of Operation

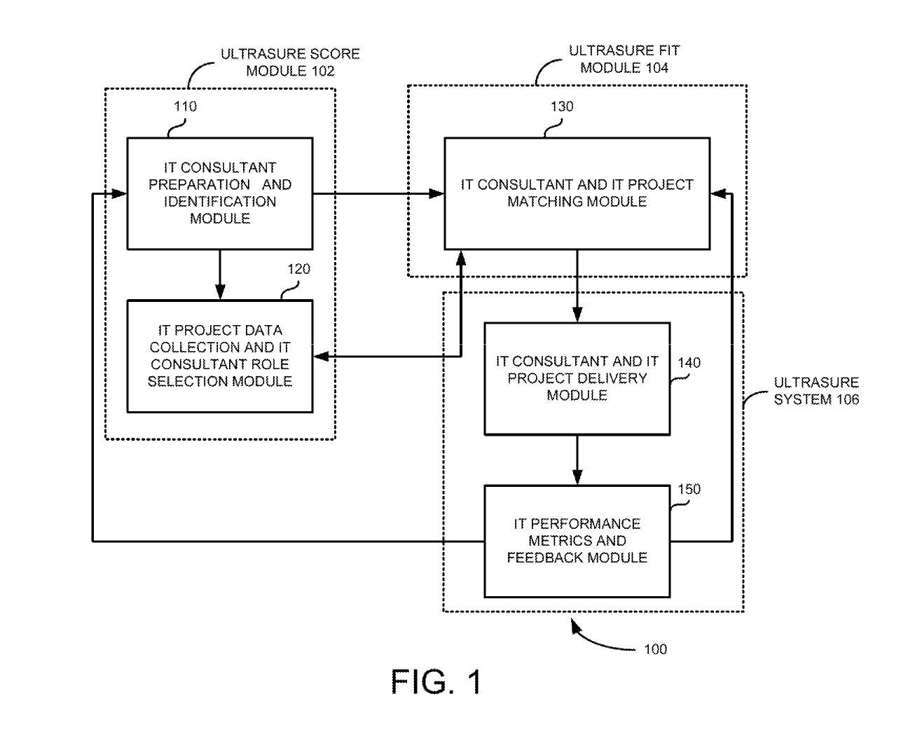

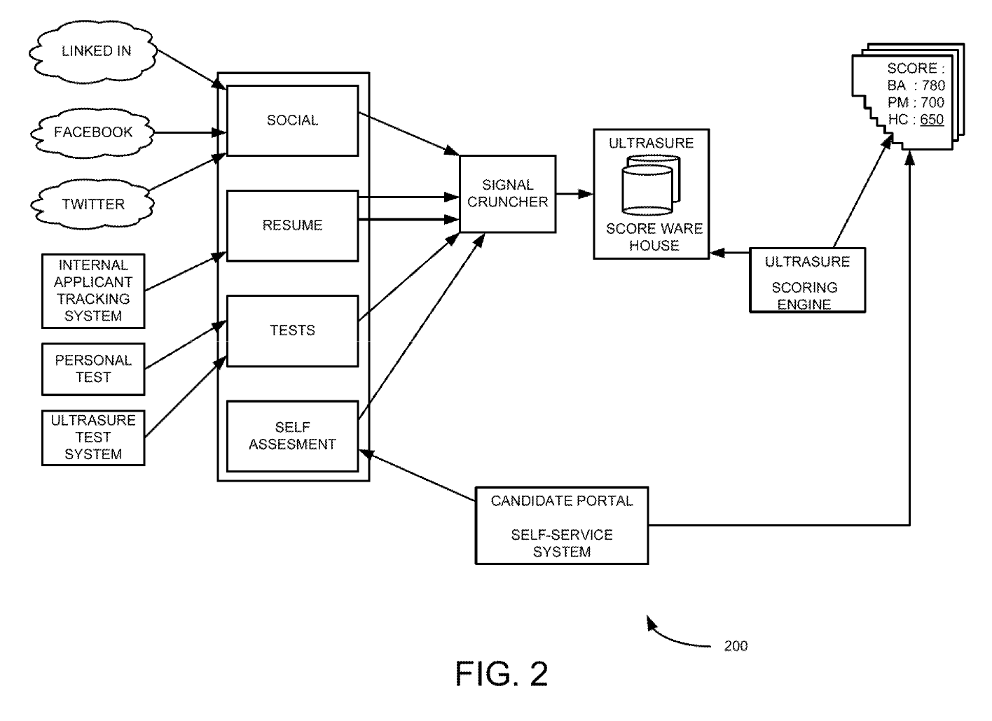

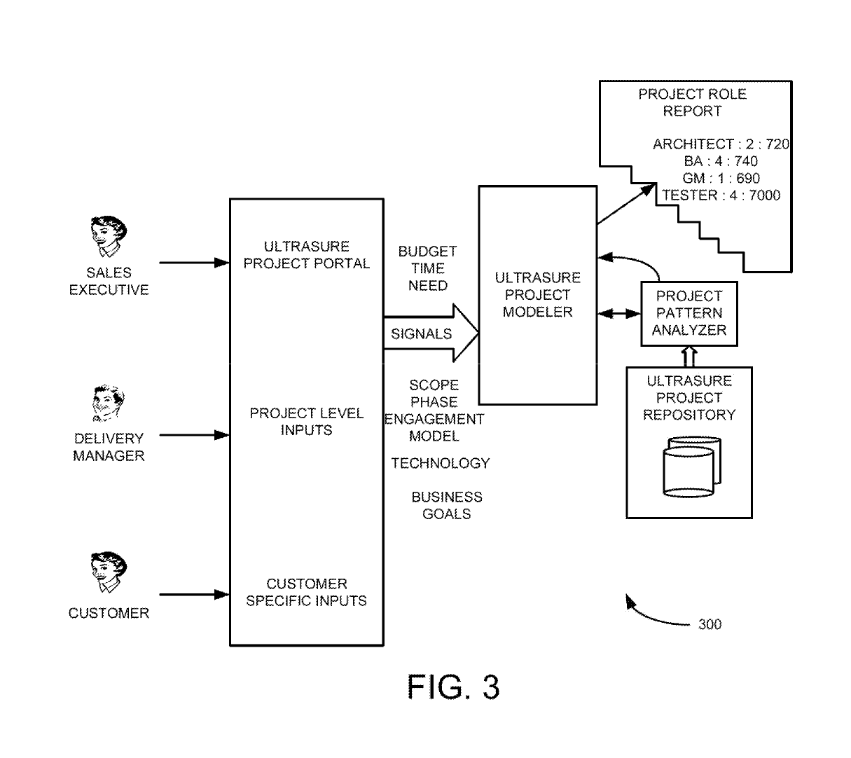

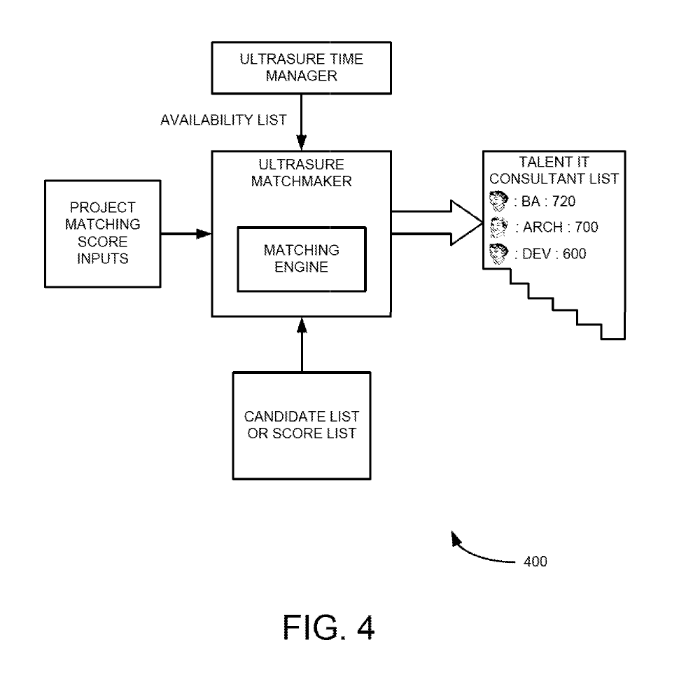

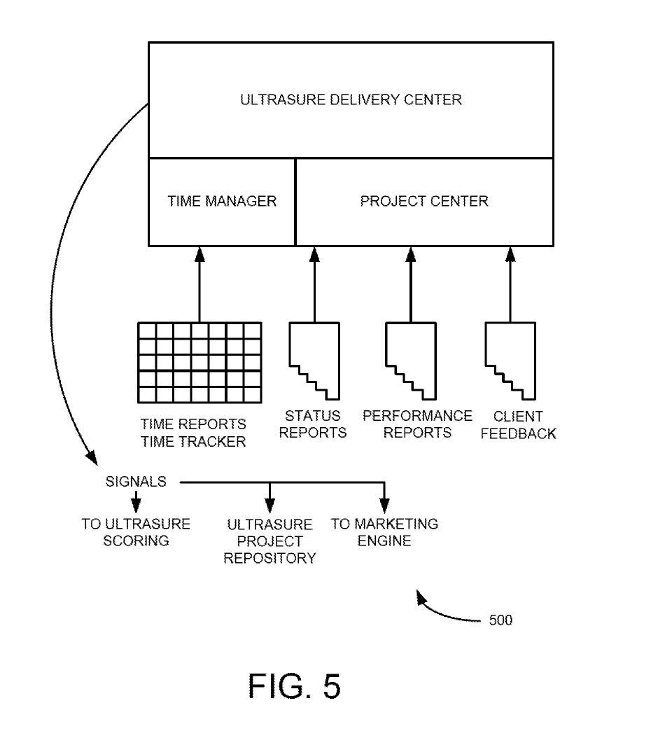

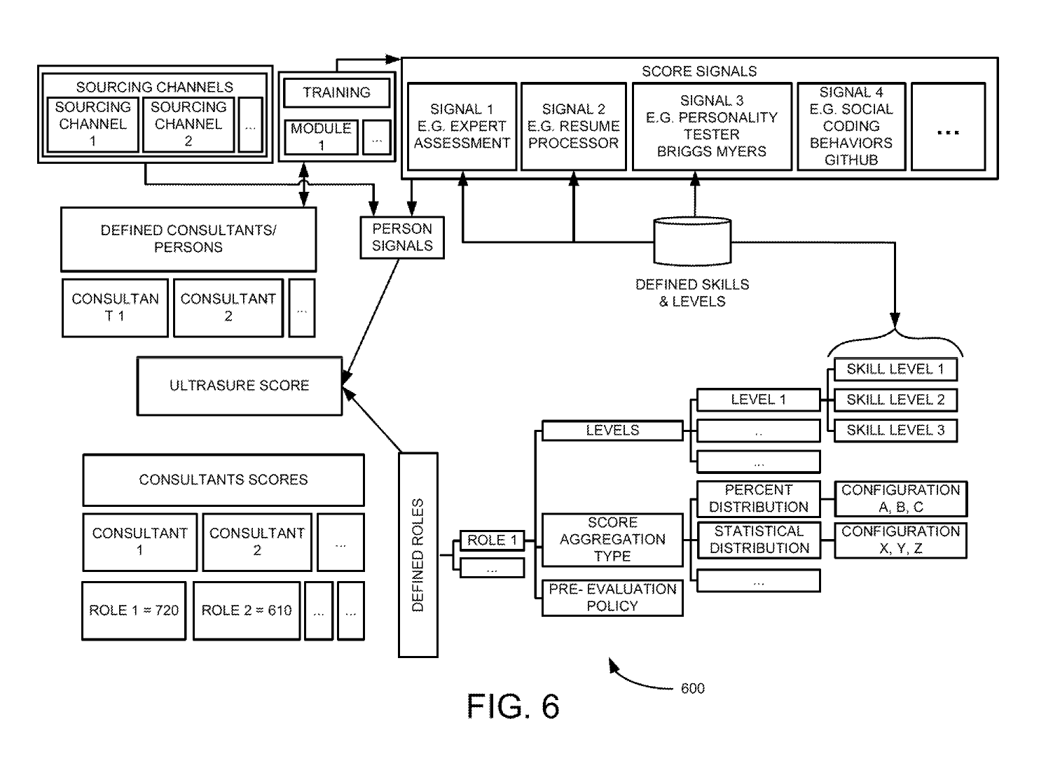

FIG. 1 is a block diagram illustrating system 100 for selecting and managing IT consultants for IT projects, according to an example embodiment. As shown in FIG. 1, computing system 100 includes an UltraSure Score module 102, which in turn includes an IT consultant preparation module 110 and an IT project data collection that is communicatively coupled with an IT consultant role selection module 120. Further as shown in FIG. 1, an UltraSure Fit module 104 includes an IT consultant and IT project matching module 130 that is communicatively coupled with the IT consultant preparation and identification module 110 and the IT project data collection and IT consultant role selection module 120. Furthermore as shown in FIG. 1, an UltraSure System 106 includes an IT consultant and IT project delivery module 140 that is communicatively coupled with the IT consultant and IT project matching module 130. In addition as shown in FIG. 1, an IT performance metrics and feedback module 150 is communicatively coupled with the IT consultant and IT project delivery module 140. FIGS. 2-5 shows major components/modules of IT consultant preparation and identification module 110, IT project data collection and IT consultant role selection module 120, IT consultant and IT project matching module 130, and IT consultant and IT project delivery module 140/IT performance metrics and feedback module 150, respectively.

In operation, the IT consultant preparation and identification module 110 defines a list of IT consultant roles that are needed for performing various types of IT projects. In some embodiments, the IT consultant roles are configurable through a list of pre-defined IT consultant roles. Also in these embodiments, the IT consultant preparation and identification module 110 can compose new roles as needed for the IT projects. Further in operation, the IT consultant preparation and identification module 110 defines each IT consultant's role along with obtaining associated IT consultant's skill score by assessing each IT consultant for a possible one of identified IT consultant roles based on configurable IT consultant skill factors. FIG. 2 illustrates operational details including major modules and components of the IT consultant preparation and identification module 110. Exemplary IT consultant roles are business analysis, architecture, development, quality assurance, and/or administrative support. Exemplary IT consultant skill factors are dimensionality, segmentation, signals from various data sources, and/or temporal dynamics. Exemplary data sources for the signals are expert assessment, resume processor, personality tester, social coding behavior, social network behavior, self assessment, performance assessment, experience verifier, certifications and the like. In these embodiments, the operation includes identifying IT consultant roles each IT consultant is capable of performing using the IT consultant skill factors. Further in these embodiments, the IT consultant preparation and identification module 110 identifies and prepares each IT consultant for specific defined IT consultant roles that they are capable of performing.

In some embodiments, IT consultant score is obtained by weighing each IT consultant against each IT consultant role they are capable of performing to ensure a good fit to the assigned IT consultant roles. Further in these embodiments, each IT consultant undergoes proper training and enablement program for the assigned IT consultant roles. This training can span a few days to several months, which usually includes shadowing these IT consultant roles on current IT projects. Further, each IT consultant is measured on a continuous basis to provide updated measurements on a real-time basis to the IT consultant preparation and identification module 110.

In some embodiments, the IT consultant preparation and identification module 110 identifies project specific parameters. The IT consultant preparation and identification module 110 then establishes a customized training for each deployed IT consultant based on the identified project specific parameters. Further the IT consultant preparation and identification module 110 is configured to train each deployed IT consultant based on the established customized training. The IT consultant preparation and identification module 110 is then configured to certify the IT consultant based on the outcome of the training.

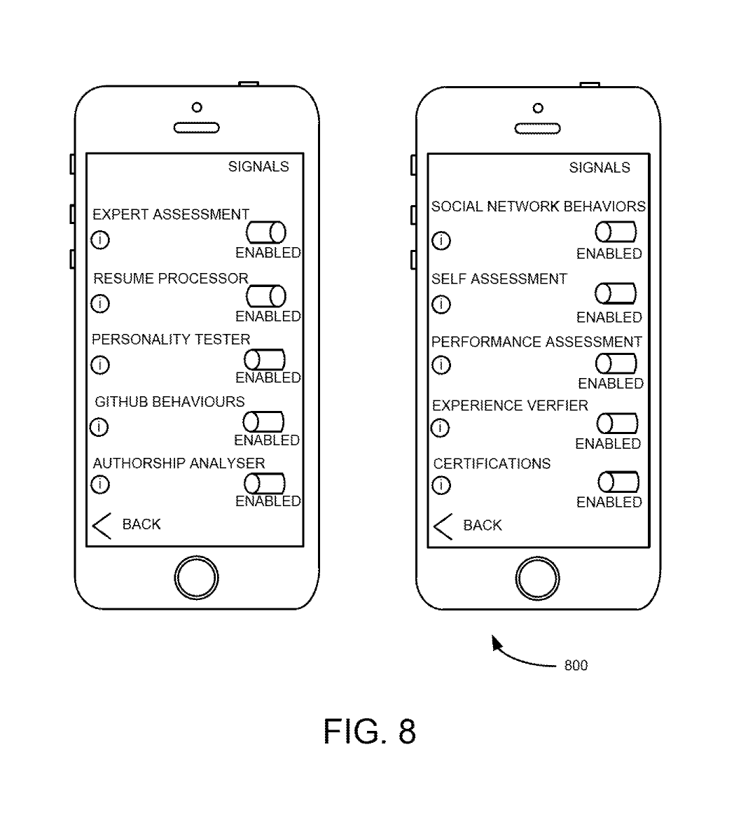

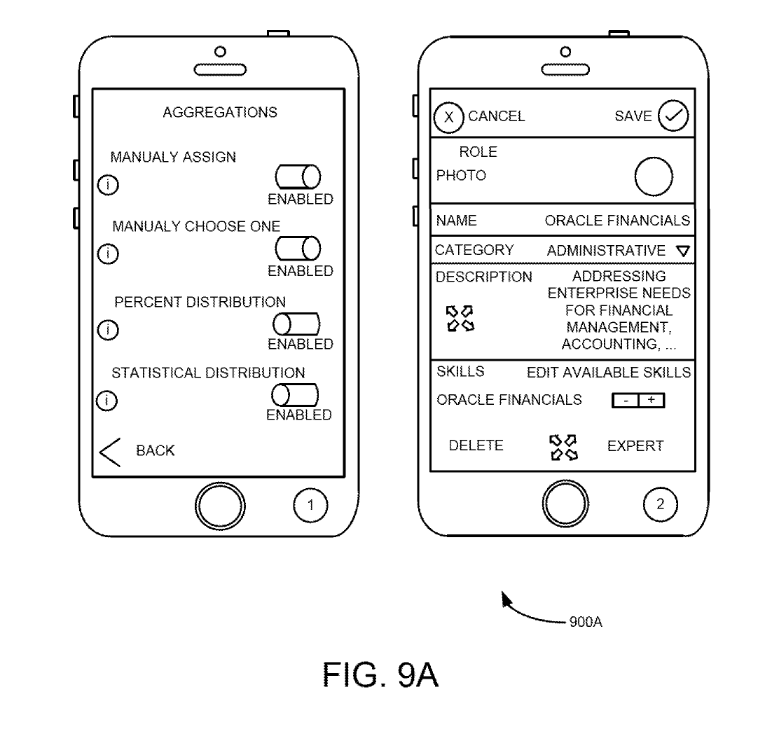

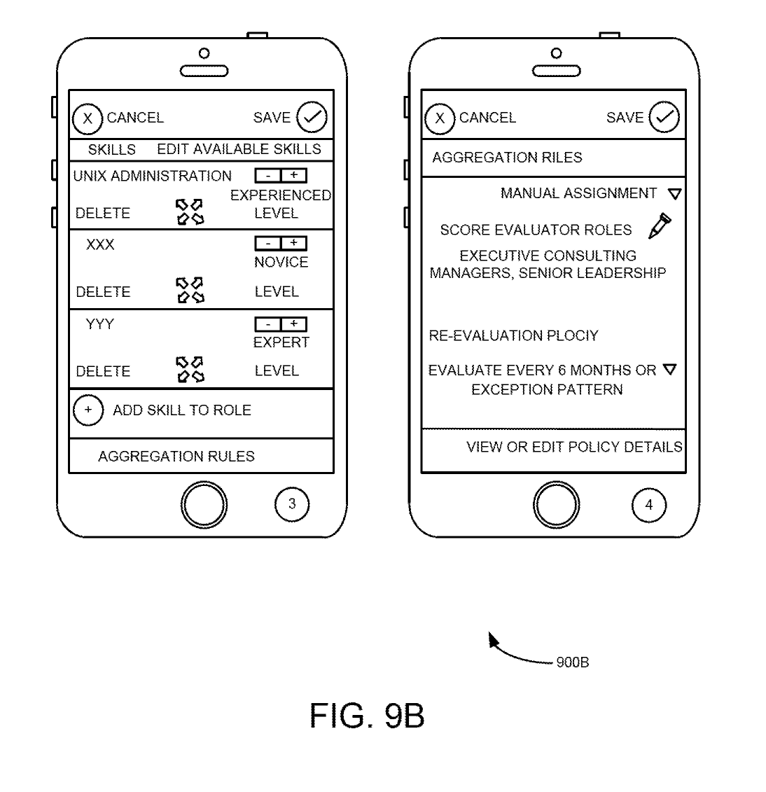

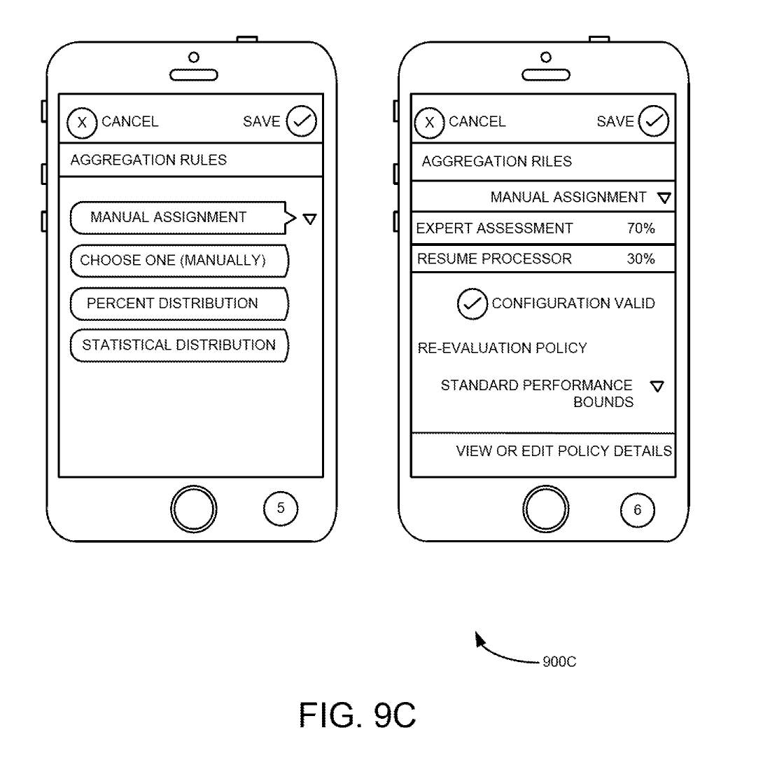

In these embodiments, IT consultant preparation and identification module 110 obtains the IT consultant score for each IT consultant based on dimensionality, segmentation, signals obtained from various data sources and/or temporal dynamics. For example, the IT consultant score is dimensional, where the individual dimensions are based on extensive domain knowledge. Dimensions may include development, business analysis, project management, platforms and so on. This is similar to Fair Isaac Corporation (FICO®) credit score, which can range from 300 to 850. Segmentation includes bucketing talent into specific groups, within which scores are compared. In these embodiments, signals from various data sources assist in overall IT consultant scoring. Signals may be added or removed, as shown in example FIGS. 8 and 9, over time as the available data sources to obtain IT consultant score becomes available or is no longer relevant. Further in these embodiments, the temporal dynamics, which can be time-based capability that can come in two forms: (1) maturing the score over time with more updated data from the same signals and (2) how to incorporate new signals into the system or even those removed from the system and managing this impact on the IT consultant score.

For example, for an IT consultant defined with a specific IT consultant role, such as a developer, various data sources, such as resumes, project management databases, various testing means, manager evaluations and so on are used to determine the IT consultant score. An example data (signal) in this context would be a user-defined rule on an IT consultant's resume for the IT consultant role of “developer”: if work-experience>5 years and title=“senior developer” then score=800. One can envision that the same resume data source can provide alternate signals for the same rule as well. For example, a statistical learning algorithm may be used to determine a developer score for the very same IT consultant based on the data elements in the resume. Using this approach may result in an IT consultant score of 700. These IT consultant scores can be combined in any number of ways. For example, an unsupervised simple average mechanism identifies a composite IT consultant score of (800+700)/2 (i.e., 750). A supervised weighting scheme can identify specific weights for each signal to optimize the composite score derived from the two signals. For example, if back testing over years of data reveals that weights of (0.1, 0.9) optimize the developer score in that the score best predicts project performance, then the composite IT consultant score is 0.1*800+0.9*700=710.

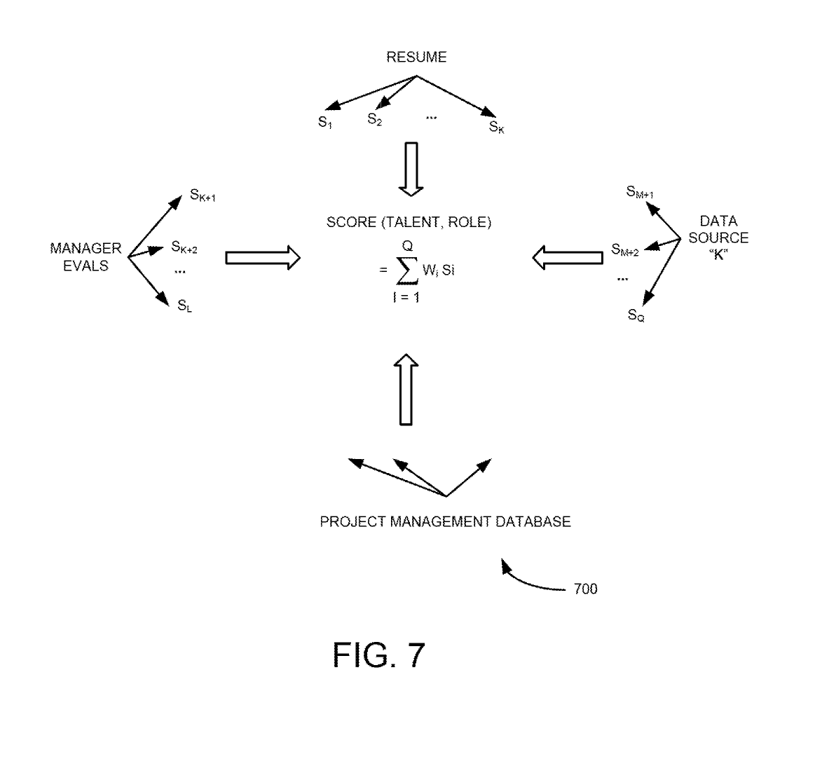

FIG. 7 illustrates an example signal driven scheme used in obtaining the IT consultant score. In this example illustration, a talent is assigned a score for a specific role. Various data sources are used to construct signals that are then combined to yield an overall score. Below outlines presents specific formalisms:
Data Sources. Let D={D₁, D₂, . . . , D_{K}} be the set of K data sources. D₁ might be “resumes”, D₂ might be “manager evaluations”, D₃ might be “stack overflow content”, etc.
Roles. Let R={R₁, R₂, . . . , R_{M}} be the set of M roles in the system. R₁ might be “developer”, R₂ might be “business analyst”, R₃ might be “QA engineer”, etc. Note that there is a hierarchy that can be imposed on R. For instance, R₇ might be “C# developer”, which is a child of R₁. Enabling hierarchies on R can permit broader approaches of score inheritance based on hierarchical relationship.
Signals. A signal is a function S_{A}(Dᵢ, Rⱼ), which takes a data source and role to computes a score. Note that for a given role and data source there can be multiple signals that provide scores based on different heuristics. Related to this, let S_{i,j}={S₁, S₂, . . . , S_{L}} be the set of L signals that provides scores for role Rⱼ on data source Dᵢ.
Score. If there is only one source Dᵢ then a composite score is computed as follows: score(talent, role)=w_{1.}S₁(Dᵢ, Rⱼ)+w_{2.}S₂(Dᵢ, Rⱼ)+ . . . +w_{L.}S_{L}(Dᵢ, Rⱼ), where Σwᵢ=1, where w are weights. More generally, if s(t, r, D) represents the score of talent t in role r based on data source D, then s(t, r)—the score across all data sources, is computed similarly as s(t, r)=Σwᵢ.s(t, r, Dᵢ).

FIG. 8 illustrates example configurable data sources signals. As previously noted above, signals support the UltraSure Score module 102 shown in FIG. 1. FIG. 8 shows the configuration of these data sources for these signals, how they can be added or removed from the overall system. (For ease of exposition, the figure calls “Signals” rather than the more elaborate “data sources for signals”.) It should be noted that listing in FIG. 8 does not represent all of the possible signal sources for the system. The UltraSure Score module 102 (shown in FIG. 1) may be configured to support an extensible scoring mechanism by way of these flexible Signal source configurations. It can be seen that more signal sources may be added to or removed from the system. This flexibility allows the scoring to more accurately reflect data from systems and human data sources aggregated into a cohesive score.

FIGS. 9A-9C illustrates an example configurable score aggregation of signals using a mobile app interface. The UltraSure Score module 102 (shown in FIG. 1) allows for controlling how values from individual signal sources are aggregated into a unified score. This is where, among other places, the capabilities of temporal dynamics are managed as described above. FIG. 9A is an example of the expert user experience for such management. FIG. 9A shows the available aggregation functions. It should be noted that, like that of the extensibility of signal sources of FIG. 8, the UltraSure Score module 102 listing of aggregation capabilities in FIG. 9A is not the complete list of aggregation functions possible in the system. It can be envisioned, the UltraSure Score module 102 can be configured to support an extensible aggregation mechanism. More signal aggregation capabilities may be added to or removed from the system over time.

FIG. 9B and FIG. 9C further shows the UltraSure Score module's 102 use of aggregation in the definition of a role. The right panel illustration in FIG. 9B shows the “Manual Assignment” configuration whereby users of an authorized role receive individual signal scores from other users of the system. These authorized users then manually may assign a resulting IT consultant score (UltraSure Score module 102) based on the supplied system individual signal scores. This interaction can also be fully made interactive, such as, that in the left panel illustration in FIG. 9C showing the role definition being changed to a percent distribution aggregation approach in the right panel illustration of FIG. 9C. The right panel illustration of FIG. 9C shows the configuration of percent distribution of the individual signal scores resulting in the final UltraSure Score module 102 determined automatically by the system (requiring no further user intervention).

The aggregation approach in FIG. 9A and its usage is further highlighted in FIG. 9B and FIG. 9C. This illustrates an example flexibility of the UltraSure Score module 102 by applying flexible and extensible aggregation of signal values into a unified UltraSure Score.

A variety of approaches may be used to tailor the individual signals from each data source and for each IT consultant role. These include those based on extensive domain knowledge as well as those based on statistical learning. In the case of the resume data source for instance, each role may have human specified rules for IT consultant score ranges. In addition, a human expert, system automation (extracting specific-domain characteristics from the resume), or combination thereof may determine resumes scores. This database may then be used as the basis for learning statistical models. Below lists some example types of human specified abstract rules considering talent “t” in role “r”.
If field 1 contains “developer”, field 2=6 years work experience, field 3 contains open source development then score=(700 to 800)
If field 3=“IIT, Delhi” and field 5=“GMAT>700” then score (750 to 800)

Once the signals are constructed, the approach outlined above can be used to generate IT consultant scores for each IT consultant talent and role.

Further in operation, IT project data collection and IT consultant role selection module 120 determines key IT consultant roles and associated IT consultant fitness scores along with numbers of each determined key IT consultant roles needed for the IT project by evaluating the IT project based on IT project profiling factors and the identified list of IT consultant roles. Exemplary IT project profiling factors are type of IT project, phase of the IT project, prior projects and so on.

One of the key ingredients to selecting key IT Consultants for project delivery and thereby make the IT project successful for execution more likely is to accurately profile the following: customer, project and specific key roles needed for project success. Most often, the process is challenged from the beginning when customers use basic, standard job descriptions for every project based on a pre-defined methodology without regard to specific requirements needed by specific efforts.

The IT project data collection and IT consultant role selection module 120 implements several features to improve the project data collection and improve the role selections that are appropriate for the project. These include:
The unique Plan, Assess, Recommend, Implement, and Sustain (PARIS) methodology to clearly ascertain the current phase of the project. The roles needed for each project phase of PARIS are different from each other although there is some overlap between the phases.
Customer is assessed by gathering both general and specific details including the use of the unique scoring framework. From these details, the customer maturity for these projects is measured.
The project is assessed in detail, the PARIS phase identified and the phase is clearly mapped out. Based on the PARIS phase the roles are identified with key unique characteristics and challenges of the project.
A fitness scorecard for each required role is generated. This scorecard is unique to the customer and the project. The scorecard is built based on past knowledge developed in modeling these roles and giving them proper weightage based on the needs of the project.
The roles are accurately profiled for: skills needed, competency level required, customer environment, project environment, and the personality traits suitable for the project.
From these profiles, a Point System for the UltraSure Fit module 104 (shown in FIG. 1) is identified for matching potential candidates.
The delivery management team also reviews the on-boarding process for the customer and project to prepare for the on-boarding process.

Given an IT project, the system 100 and the IT project data collection and IT consultant role selection module 120 are configured to identify the set of IT consultant roles needed, along with IT consultant scores of such talent in each IT consultant role, based on an approach that utilizes domain knowledge and prior data. Further, projections may be made as to when the IT consultant roles are needed, an element that is used to matching as well.

Specifically, a new IT project Pi is first compared to a set of past IT projects or IT prototype projects (expert data) when available, P={P1, P2, . . . , PX}. A distance function D1 (Pi, Pj) is used to select IT projects that are closest to P. Each IT project Pi has features {f1, f2 . . . fL}, where f1 might for instance be a project type (e.g. “agile”, “fixed bid”, or other trait). D (Pi, Pj) therefore compares IT projects based on closeness of the individual features of the IT projects. Based on this, Nearest (Pi, K) returns the set of K IT projects that are closest in distance to a given new IT project Pi.

For each PεNearest (Pi, K) the set of IT consultant roles that were used in that IT project are then extracted. These are then combined to yield a set of IT consultant roles needed that are then provided, along with Nearest (Pi, K), to a domain expert for optional review.

The output of this process yields a set of tuples <R, n, S, T>, where R is a role, n is the number of talent needed in that role, S is a score range for that role, and T is the time period where these talent are needed.

Furthermore in operation, the IT consultant and IT project matching module 130 selects the IT consultants for deploying on the IT project based on the defined IT consultant's roles and the associated IT consultant's skill scores and the determined key IT consultant roles and the associated IT consultant fitness scores along with the numbers of each determined key IT consultant roles needed for the IT project.

In an example embodiment, IT consultant selection/matching process is performed as follows:
The UltraSure Fit module 104 takes two key elements as its input: (1) the scorecards developed from the IT project data collection and (2) role selection process and the IT consultants selected for specific roles from the UltraSure Score module 102. Based on these inputs, a unique match is derived.
This matchmaking algorithm uses a unique point system to match the IT consultant score against the IT project role score.
Once the specific IT consultants are matched for a defined role on the IT project, a customer review is arranged. The UltraSure System 106 also ensures that a unique perspective is provided to the customer through this review so they receive an objective assessment of the IT consultant's profile.
The final list of IT consultants is selected and identified for on-boarding and delivery.

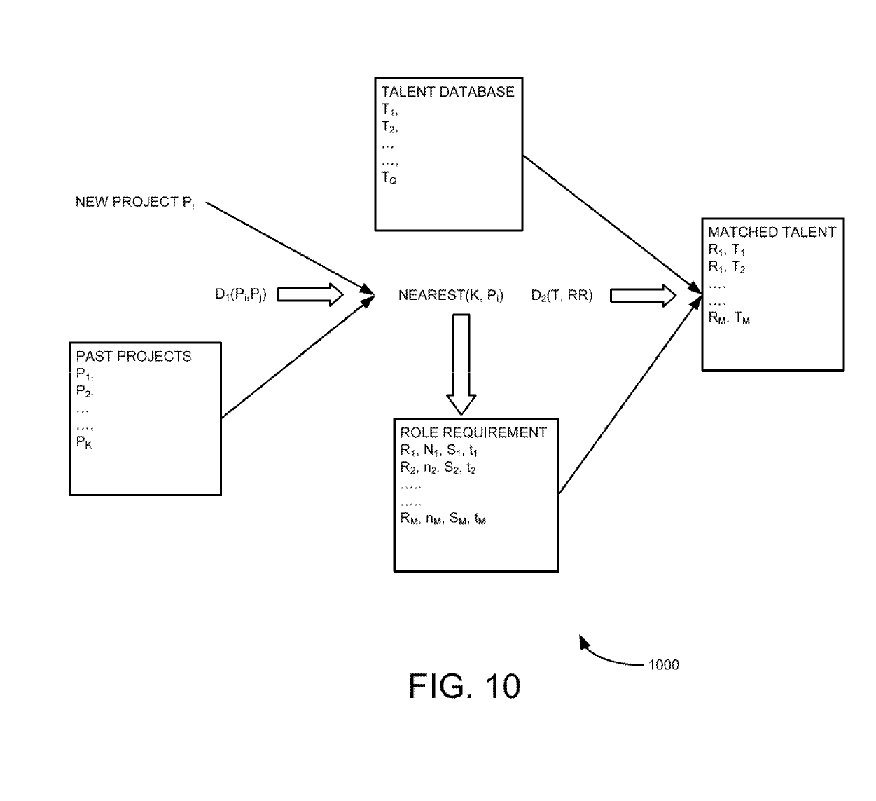

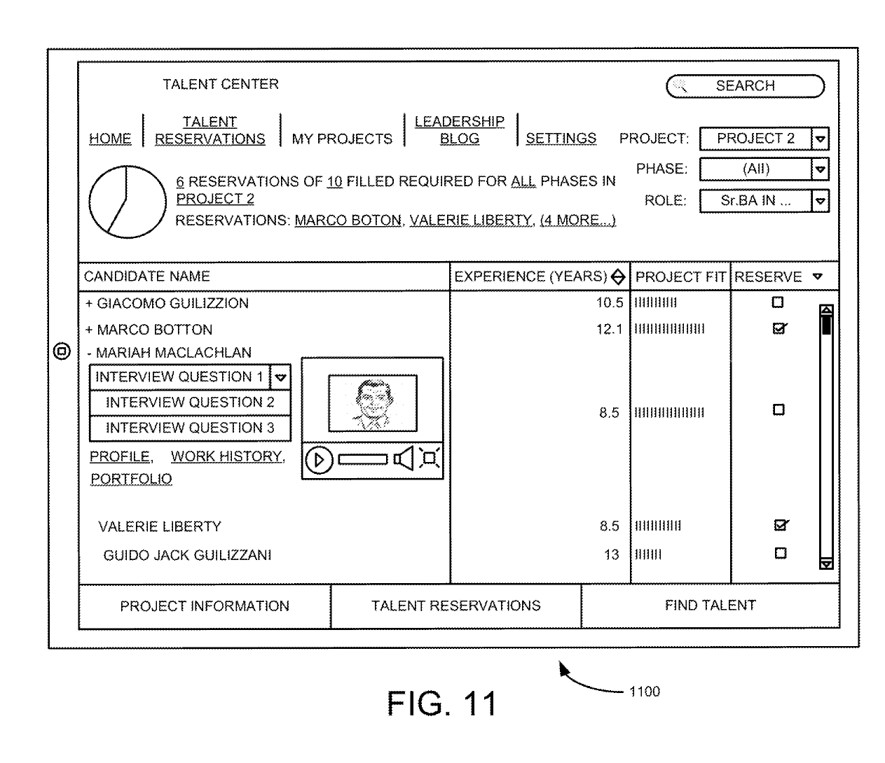

This process removes as much of the subjectivity out of the IT consultant selection process, which ensures that the probability of success of the IT consultant and the IT project is increased significantly. FIGS. 10 and 11 show example matching framework deployed in the IT consultant matching and role selection and presenting results of UltraSure Score module 102 (shown in FIG. 1) and UltraSure Fit module 104 (shown in FIG. 1) in a user friendly interface.

In addition in operation, The IT consultant and IT project delivery module 140 deploys the selected IT consultants on the IT project based on their availability. In some embodiments, a robust end-to-end, delivery management framework includes a delivery management team and an assignment of a delivery manager to monitor and manage each consultant. Further, the delivery management team is responsible for the deployed IT consultants on-boarding. The delivery team prepares the IT consultants thoroughly to each specific project by using the UltraSure system 106 (shown in FIG. 1) to orient the IT consultants for the assigned IT consultant roles in the IT project. The UltraSure system 106 provides customized on-boarding for each deployed IT consultant for each IT project.

Further in these embodiments, the delivery management team also assigns a centrally managed support team for each IT consultant through UltraSure home base. The UltraSure home base maintains the profile of the IT project and matches a resource team to ensure each deployed IT consultant is confident and does not feel alone in delivering the IT project. Each IT consultant is provided with access to a rich set of tools and assets for the IT project success available through the home base. Such tools include but are not limited to a knowledge base, resources that likewise are matched to the IT project-at-hand, and a ticketing and hotline system for delivery questions.

Furthermore in these embodiments, the delivery management framework also ensures that real-time data is collected about the customer, the IT project, and each IT consultant's performance. The monitoring is used to score the consultant and the project on a real-time basis against the forecast. This is used to provide feedback to both the IT consultant and the customer, allowing fine-tuning as needed to maintain optimal performance. On a periodic basis the delivery management team also conducts an IT consultant care survey and customer care survey. Once the IT project is completed and the IT consultant is ready to be relieved from the IT project, a thorough off-boarding process is used to off-board each IT consultant from the IT project. The delivery management framework using value points from the other elements of the end-to-end process ensures that the IT consultants are successful in executing/completing the IT project.

Moreover in operation, the IT performance metrics and feedback module 150 monitors and controls performance of each selected and deployed IT consultant based on key performance indicator (KPI) score obtained before starting on the IT project, while working on the IT project and/or upon completing the IT project by a IT performance metrics and feedback module 150.

The UltraSure system 106 including the IT performance metrics and feedback module 150 are built for continuous improvement. The IT performance metrics and feedback module 150 collects continuous data and feeds it back to the ultrasure score 102. Some example collected data are:
The information about the customer, the IT project, and the performance of the individual IT consultants are collected and fed back to the UltraSure Fit module 104 to continually improve the accuracy of the algorithm for IT consultant matching.
The information about the data, templates, and their accuracy is reviewed to ensure that the PARIS model provides accurate input to the UltraSure Fit module 104.
Metrics about each IT consultant, their specific roles in the project and their performance is collected and fed back to the UltraSure Score module 102.
This closed loop operation and the framework to continuously tune the algorithm and the scoring methodology ensures that the UltraSure system 106 provides a highly reliable framework for IT consultant's success on the deployed IT projects.

In some embodiment, the KPI score is based on performance and feedback factors. Exemplary performance and feedback factors are performance reports, submitted project reports, customer and management feedbacks, certifications, and/or administered test results. Further in these embodiments, the IT performance metrics and feedback module 150 updates selected and deployed IT consultant's skill scores based on periodically obtaining KPI score while working on the IT project and/or upon completing the IT project. Also in these embodiments, the IT performance metrics and feedback module 150 compares each obtained IT consultant KPI score associated with a defined IT consultant role to an associated benchmark KPI score. The IT performance metrics and feedback module 150 then suggests actions to improve the IT consultant's performance based on the outcome of the comparing. Exemplary suggested actions are providing expert's assistance from a panel of available experts, continuous access to senior professionals who are available on call or via online, training, and/or social and gaming theory interactions.

In one example, the executable instructions can be part of a framework that when installed can be executed by selecting and managing IT consultants for an IT project framework to implement the system 100 shown in FIG. 1. In that example, the memory resource in the system 100 can also be a portable medium such as a CD, a DVD, a flash drive, or memory maintained by a computer device from which the installation package can be downloaded and installed. In another example, the executable instructions can be part of an application or applications already installed. Here, the memory resource in the system 100 can include integrated memory such as a drive, NVRAM, DRAM or the like.

As shown in FIG. 1, the UltraSure Score module 102, the UltraSure Fit module 104 and the UltraSure system 106 can be stored in a same computing system or distributed across servers, other devices or storage mediums, or a combination thereof. For example, an instance of the UltraSure Score module 102, the UltraSure Fit module 104 and the UltraSure system 106 can be executing on each one of the processor resources of the server devices. The engines and/or modules can complete or assist completion of operations performed in describing another engine and/or module. The engines, drivers and/or modules can perform the example methods described in connection with FIG. 1.

Numerous specific details are set forth herein, such as data formats and code sequences and the like, in order to provide a thorough understanding of the described techniques. The embodiments described also can be practiced without some of the specific details described herein, or with other specific details, such as changes with respect to the ordering of the logic, different logic, different architectures, or the like. Thus, the scope of the techniques and/or functions described is not limited by the particular order, selection, or decomposition of aspects described with reference to any particular routine, module, component, or the like.

### Example Processes

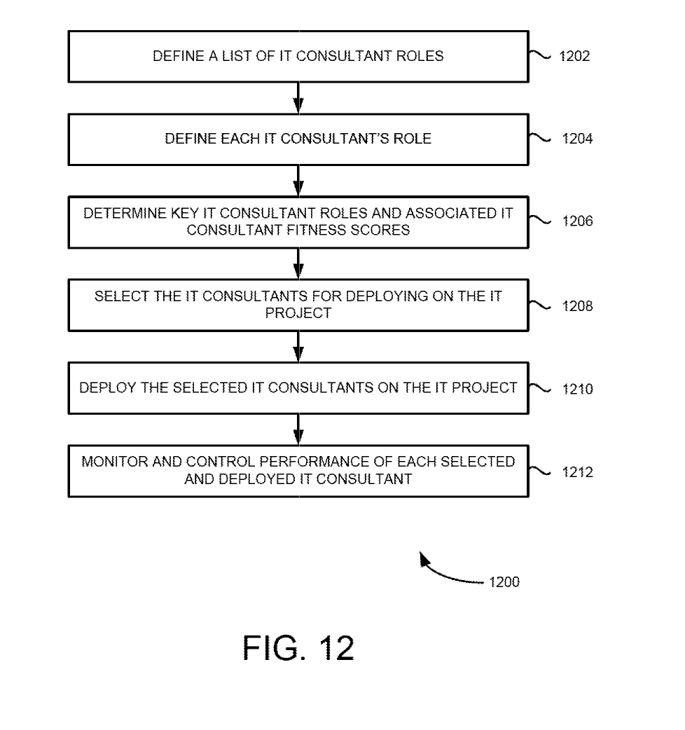

FIG. 12 is a flow diagram of process 1200, for selecting and managing IT consultants for IT projects, according to an example embodiment.

At block 1202, process 1200 defines a list of IT consultant roles that are needed for performing various types of IT projects. Example IT consultant roles are business analysis, architecture, development, quality assurance, administrative support, and so on.

At block 1204, each IT consultant's role along with obtaining associated IT consultant's skill score are defined by assessing each IT consultant for a possible one of identified IT consultant roles based on configurable IT consultant skill factors. Example configurable IT consultant skill factors are dimensionality, segmentation, signals from various data sources, temporal dynamics and the like.

At block 1206, key IT consultant roles and associated IT consultant fitness scores along with numbers of each determined key IT consultant roles needed for the IT project are determined by evaluating the IT project based on IT project profiling factors and the identified list of IT consultant roles. Example IT project profiling factors are customer type, IT project type, phase of the IT project, prior project type and the like.

At block 1208, the IT consultants for deploying on the IT project are selected based on the defined IT consultant's roles and the associated IT consultant's skill scores and the determined key IT consultant roles and the associated IT consultant fitness scores along with the numbers of each determined key IT consultant roles needed for the IT project by a IT consultant and IT project matching module.

At block 1210, the selected IT consultants are deployed on the IT project based on their availability by an IT consultant and IT project delivery module. At block 1212, each selected and deployed IT consultant's performance is monitored and controlled based on key performance indicator (KPI) score obtained before starting on the IT project, while working on the IT project and/or upon completing the IT project by a IT performance metrics and feedback module. In these embodiments, the KPI score is based on performance and feedback factors and wherein the performance and feedback factors are performance reports, submitted project reports, customer and management feedbacks, certifications, administered test results, and the like.

In some embodiments, project specific parameters are identified. A customized training is then established for each deployed IT consultant based on the identified project specific parameters. Each deployed IT consultant is then trained based on the established customized training. Each IT consultant is then certified based on the outcome of their training.

In some embodiments, a selected and deployed IT consultant's skill score is updated based on periodically obtaining the KPI score while working on the IT project and/or upon completing the IT project by a IT performance metrics and feedback module. Further in some embodiments, each obtained IT consultant KPI score associated with a defined IT consultant role is compared to an associated benchmark KPI score. Actions to improve the IT consultant's performance are then suggested based on the outcome of the comparing. Example suggested actions are providing experts assistance from a panel of available experts, continuous access to senior professionals who are available on call or via online, training, social and gaming theory interactions, and so on.

Process 1200 for selecting and managing IT consultants for IT projects is explained in more detail above with reference to the system diagram 100 shown in FIG. 1.

In an example embodiment, components/modules of UltraSure Score module 102, UltraSure Fit module 104 and UltraSure system 106 are implemented using standard programming techniques. In other embodiments, UltraSure Score module 102, UltraSure Fit module 104 and UltraSure system 106 may be implemented as instructions processed by a VM that executes as one of other programs.

Furthermore, in some embodiments, some or all of the components of UltraSure Score module 102, UltraSure Fit module 104 and UltraSure system 106 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques.

Further, from the foregoing it will be appreciated that, although specific embodiments have been described herein for purposes of illustration, various modifications may be made without deviating from the spirit and scope of this disclosure. For example, the methods, techniques, and systems for optimizing guest OS utilization cost in a volume based licensing model in a virtualized datacenter are applicable to other architectures or in other settings. For example, the described techniques may be employed as part of a cloud-based computing resource offering, wherein customers may pay to have higher importance levels associated with their activities, in order to obtain higher levels of service or availability. As another example, the described techniques may be employed to allocate resources or schedule CPU time at the process level within an operating system. Also, the methods, techniques, and systems discussed herein are applicable to differing protocols, communication media (optical, wireless, cable, etc.) and devices (e.g., desktop computers, wireless handsets, electronic organizers, personal digital assistants, tablet computers, portable email machines, game machines, pagers, navigation devices, etc.).

1. A computer implemented method for selecting and managing information technology (IT) consultants for an IT project, comprising:
defining a list of IT consultant roles that are needed for performing various types of IT projects by an IT consultant preparation and identification module;
defining each IT consultant's role along with obtaining associated IT consultant's skill score by assessing each IT consultant for a possible one of identified IT consultant roles based on configurable IT consultant skill factors by the IT consultant preparation and identification module;
determining key IT consultant roles and associated IT consultant fitness scores along with numbers of each determined key IT consultant roles needed for the IT project by evaluating the IT project based on IT project profiling factors and the identified list of IT consultant roles by a IT project data collection and IT consultant role selection module;
selecting the IT consultants for deploying on the IT project based on the defined IT consultant's roles and the associated IT consultant's skill scores and the determined key IT consultant roles and the associated IT consultant fitness scores along with the numbers of each determined key IT consultant roles needed for the IT project by a IT consultant and IT project matching module; and
deploying the selected IT consultants on the IT project based on their availability by an IT consultant and IT project delivery module.

2. The method of claim 1, further comprising:
monitoring and controlling performance of each selected and deployed IT consultant based on key performance indicator (KPI) score obtained before starting on the IT project, while working on the IT project and/or upon completing the IT project by a IT performance metrics and feedback module.

3. The method of claim 1, wherein the IT consultant roles are business analysis, architecture, development, quality assurance, and/or administrative support.

4. The method of claim 1, wherein the configurable IT consultant skill factors are dimensionality, segmentation, signals from various data sources, and/or temporal dynamics.

5. The method of claim 1, wherein the IT project profiling factors are customer type, IT project type, phase of the IT project, and prior project type.

6. The method of claim 1, further comprising:
identifying project specific parameters;
establishing a customized training for each deployed IT consultant based on the identified project specific parameters;
training each deployed IT consultant based on the established customized training; and
certifying each IT consultant based on the outcome of the training.

7. The method of claim 2, wherein the KPI score is based on performance and feedback factors and wherein the performance and feedback factors are performance reports, submitted project reports, customer and management feedbacks, certifications, and/or administered test results.

8. The method of claim 2, further comprising;
updating selected and deployed IT consultant's skill score based on periodically obtaining KPI score while working on the IT project and/or upon completing the IT project by a IT performance metrics and feedback module.

9. The method of claim 8, further comprising:
comparing each obtained IT consultant KPI score associated with associated defined IT consultant role to an associated benchmark KPI score; and
suggesting actions to take to improve the IT consultant's performance based on the outcome of the comparing.

10. The method of claim 9, wherein the suggested actions are providing experts assistance from a panel of available experts, continuous access to senior professionals who are available on call or via online, training, and/or social and gaming theory interactions.

11. A non-transitory computer-readable storage medium including instructions that are configured, when executed by a computing system, to perform a method for selecting and managing information technology (IT) consultants for an IT project, the method comprising:
defining each IT consultant's role along with obtaining associated IT consultant's skill score by assessing each IT consultant for a possible one of identified IT consultant roles based on configurable IT consultant skill factors by the IT consultant preparation and identification module;
determining key IT consultant roles and associated IT consultant fitness scores along with numbers of each determined key IT consultant roles needed for the IT project by evaluating the IT project based on IT project profiling factors and the identified list of IT consultant roles by a IT project data collection and IT consultant role selection module;
selecting the IT consultants for deploying on the IT project based on the defined IT consultant's roles and the associated IT consultant's skill scores and the determined key IT consultant roles and the associated IT consultant fitness scores along with the numbers of each determined key IT consultant roles needed for the IT project by a IT consultant and IT project matching module; and
deploying the selected IT consultants on the IT project based on their availability by an IT consultant and IT project delivery module.

12. The non-transitory computer-readable storage medium of claim 11, further comprising:
monitoring and controlling performance of each selected and deployed IT consultant based on key performance indicator (KPI) score obtained before starting on the IT project, while working on the IT project and/or upon completing the IT project by a IT performance metrics and feedback module.

13. The non-transitory computer-readable storage medium of claim 11, wherein the IT consultant roles are business analysis, architecture, development, quality assurance, and/or administrative support.

14. The non-transitory computer-readable storage medium of claim 11, wherein the configurable IT consultant skill factors are dimensionality, segmentation, signals from various data sources, and/or temporal dynamics.

15. The non-transitory computer-readable storage medium of claim 11, wherein the IT project profiling factors are type of customer, type of IT project, phase of the IT project, and prior project.

16. The non-transitory computer-readable storage medium of claim 11, further comprising:
identifying project specific parameters;
establishing a customized training for each deployed IT consultant based on the identified project specific parameters;
training each deployed IT consultant based on the established customized training; and
certifying each IT consultant based on the outcome of the training.

17. The non-transitory computer-readable storage medium of claim 12, wherein the KPI score is based on performance and feedback factors and wherein the performance and feedback factors are performance reports, submitted project reports, customer and management feedbacks, certifications, and/or administered test results.

18. The non-transitory computer-readable storage medium of claim 12, further comprising;
updating selected and deployed IT consultant's skill score based on periodically obtaining KPI score while working on the IT project and/or upon completing the IT project by a IT performance metrics and feedback module.

19. The non-transitory computer-readable storage medium of claim 18, further comprising:
comparing each obtained IT consultant KPI score associated with associated defined IT consultant role to an associated benchmark KPI score; and
suggesting actions to take to improve the IT consultant's performance based on the outcome of the comparing.

20. The non-transitory computer-readable storage medium of claim 19, wherein the suggested actions are providing experts assistance from a panel of available experts, continuous access to senior professionals who are available on call or via online, training, and/or social and gaming theory interactions.

21. A computing system for selecting and managing information technology (IT) consultants for an IT project, the system comprising:
processor; and
memory, wherein the memory is communicatively coupled to the processor, wherein the memory comprising an UltraSure Score module, UltraSure Fit module, and UltraSure system, and they are configured to:
define a list of IT consultant roles that are needed for performing various types of IT projects by an IT consultant preparation and identification module;
define each IT consultant's role along with obtaining associated IT consultant's skill score by assessing each IT consultant for a possible one of identified IT consultant roles based on configurable IT consultant skill factors by the IT consultant preparation and identification module;
determine key IT consultant roles and associated IT consultant fitness scores along with numbers of each determined key IT consultant roles needed for the IT project by evaluating the IT project based on IT project profiling factors and the identified list of IT consultant roles by a IT project data collection and IT consultant role selection module;
select the IT consultants for deploying on the IT project based on the defined IT consultant's roles and the associated IT consultant's skill scores and the determined key IT consultant roles and the associated IT consultant fitness scores along with the numbers of each determined key IT consultant roles needed for the IT project by a IT consultant and IT project matching module; and
deploy the selected IT consultants on the IT project based on their availability by an IT consultant and IT project delivery module.

22. The computing system of claim 21, further configured to:
monitor and control performance of each selected and deployed IT consultant based on key performance indicator (KPI) score obtained before starting on the IT project, while working on the IT project and/or upon completing the IT project by a IT performance metrics and feedback module.

23. The computing system of claim 21, wherein the IT consultant roles are business analysis, architecture, development, quality assurance, and/or administrative support.

24. The computing system of claim 21, wherein the configurable IT consultant skill factors are dimensionality, segmentation, signals from various data sources, and/or temporal dynamics.

25. The computing system of claim 21, wherein the IT project profiling factors are type of customer, type of IT project, phase of the IT project, and prior project.

26. The computing system of claim 21, further configured to:
identify project specific parameters;
establish a customized training for each deployed IT consultant based on the identified project specific parameters;
train each deployed IT consultant based on the established customized training; and
certify each IT consultant based on the outcome of the training.

27. The computing system of claim 22, wherein the KPI score is based on performance and feedback factors and wherein the performance and feedback factors are performance reports, submitted project reports, customer and management feedbacks, certifications, and/or administered test results.

28. The computing system of claim 22, further configured to;
update selected and deployed IT consultant's skill score based on periodically obtaining KPI score while working on the IT project and/or upon completing the IT project by a IT performance metrics and feedback module.

29. The computing system of claim 28, further configured to:
compare each obtained IT consultant KPI score associated with associated defined IT consultant role to an associated benchmark KPI score; and
suggest actions to take to improve the IT consultant's performance based on the outcome of the comparing.

30. The computing system of claim 29, wherein the suggested actions are providing experts assistance from a panel of available experts, continuous access to senior professionals who are available on call or via online, training, and/or social and gaming theory interactions.
